(19) United States
(12) Patent Application Publication
(10) Pub. No.: US 2006/0221122 A1
(43) Pub. Date: Oct. 5, 2006

(54) Inkjet head cleaning system and inkjet head cleaning method

(75) Inventors: Seong-Gyu Kwon, Gyeonggi-do (KR); Yoon-Ho Kang, Gyeonggi-do (KR); Jang-Sub Kim, Gyeonggi-do (KR); Byoung-Joo Kim, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/391,938

(22) Filed: Mar. 28, 2006

(30) Foreign Application Priority Data
Apr. 1, 2005 (KR) 10-2005-0027539

(51) Int. Cl. B41J 2/165

(52) U.S. Cl. 347/30

(57) ABSTRACT

An inkjet head cleaning system including a solvent shower to spray a solvent toward a lower surface of the inkjet head for dissolving contaminants of the lower surface, a suction apparatus apart from the solvent shower to suck the dissolved contaminants, and an air blower apart from the suction apparatus to blow air toward the lower surface for drying the solvent. The inkjet head cleaning system and a method using thereof removes contaminants without damage of the under surface of the inkjet head by using solvent. A brush can also be used to remove hardened contaminants remaining on the inkjet head.

### CROSS-REFERENCE TO RELATED APPLICATION

This application claims priority to Korean Patent Application No. 2005-027539, filed on Apr. 1, 2005, the disclosure of which is hereby incorporated herein by reference in its entirety for all purposes.

### BACKGROUND

1. Field of the Invention

The present invention relates generally to an inkjet head cleaning system and a method of cleaning an inkjet head.

2. Description of Related Art

Conventionally, an inkjet printing system can be used to form organic layers of organic light emitting displays (OLEDs) including organic light emitting layers, color filters and alignment films of liquid crystal displays (LCDs).

The inkjet printing system has an inkjet head including a plurality of nozzles, through which a volume of ink is dispensed to a portion of area of a substrate to form patterns of the organic layers, the color filters, and the alignment films. However, when the nozzles of the inkjet head are contaminated, ink dispersion from the nozzles can become less linear and result in larger ink dispersions after a volume of ink is dispensed, which can lead to dispensing ink to a neighboring area other than the desired area. Also, a heavy contamination of a nozzle may result in blockage of the nozzle and cause ink to accumulate in the nozzle, which can prevent the nozzle from properly dispensing ink. To reduce these problems, the present invention provides an inkjet head cleaning system and a method of using the inkjet head cleaning system without damaging the inkjet head.

### SUMMARY

According to one aspect of the present invention, an inkjet cleaning system and method is provided to remove contaminants of along a lower surface of an inkjet head, e.g., in and around nozzles of the inkjet head, with a solvent.

In an exemplary embodiment of an inkjet head cleaning system according to the present invention, the inkjet head cleaning system includes a solvent shower spraying a solvent toward the lower surface of the inkjet head for dissolving contaminants in and on the inkjet head, such as in and around the nozzles, a suction apparatus apart from the solvent shower to suck the dissolved contaminants from the inkjet head, and an air blower apart from the suction apparatus to blow air toward the lower surface of the inkjet head for drying the solvent.

In another embodiment, the inkjet head cleaning system further comprises a brushing apparatus to roll in contact with the lower surface of the inkjet head and remove contaminants from the lower surface of the inkjet head.

In an exemplary method of cleaning an inkjet head according to this present invention, the method includes discharging ink from inside the inkjet head, spraying a solvent toward a lower surface of the inkjet head to dissolve contaminants on and around the surface, sucking the dissolved contaminants from the inkjet head, and blowing air toward the lower surface of the inkjet head to dry the solvent.

In another embodiment, the method further comprises contacting the lower surface of the inkjet head with a brushing apparatus and rolling the brushing apparatus to remove the contaminants.

### BRIEF DESCRIPTION OF THE DRAWINGS

The features of the present invention will become more apparent to those of ordinary skill in the art by describing in detail exemplary embodiments thereof with reference to the attached drawings, in which:

FIG. 1 is a systematically cross-sectional view of an inkjet cleaning system according to an embodiment of the present invention;

FIG. 2 is a perspective view showing a plurality of inkjet head units to form color filters according to an embodiment of the present invention;

FIG. 3 is a plan view to illustrate an inkjet process of forming color filters by using a plurality of inkjet head units;

FIG. 4 is a perspective view of one of the inkjet head units shown in FIG. 2;

FIG. 5 is a plan view of the inkjet head unit shown in FIG. 4;

FIG. 6 is a view showing a process of dispensing ink to form color filters by using an inkjet head according to an embodiment of the present invention;

FIG. 7 is a plan view of a thin film transistors array panel according to an embodiment of the present invention;

FIG. 8 is a plan view of a color filter array panel according to an embodiment of the present invention;

FIG. 9 is a plan view of assembling a thin film transistor array panel of FIG. 7 and a color filter array panel of FIG. 8 to form a liquid crystal display;

FIG. 10 is a cross sectional view taken along the line X-X′ of the liquid crystal display of FIG. 9;

FIG. 11 is a cross sectional view taken along the line XI-XI′ and XI′-XI″ of FIG. 9;

FIG. 12 is a plan view of an organic light emitting display using a thin film transistor film array according to an embodiment of the present invention;

FIG. 13 is a cross sectional view taken along the line XIII-XIII′ of the organic light emitting display of FIG. 12;

FIG. 14 is a cross sectional view taken along the line XIV-XIV′ of the organic light emitting display of FIG. 12;

Use of the same reference symbols in different figures indicates similar or identical items.

### DETAILED DESCRIPTION

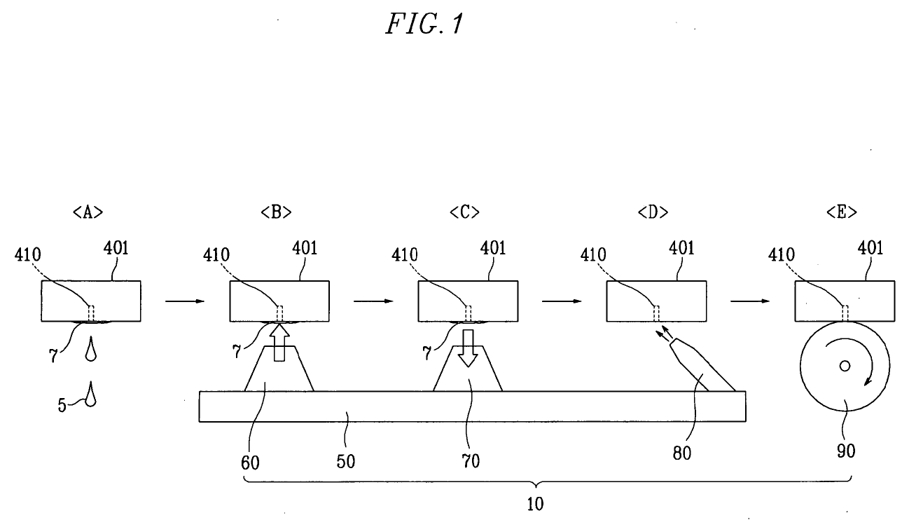

FIG. 1 is a systematically cross-sectional view of an inkjet head cleaning system 10 according to an embodiment of the present invention. Inkjet head cleaning system 10 includes a solvent shower 60, a suction apparatus 70, an air blower 80, and a roll brushing apparatus 90. Solvent shower 60, suction apparatus 70, and air blower 80 can be installed on a same frame 50 or each on a separate frame (not shown).

Solvent shower 60 sprays a solvent a lower surface of an inkjet head 410, especially around a nozzle 410 of inkjet head 410, to dissolve contaminants 7 that may be present in or around nozzle 410.

Suction apparatus 70, which is apart from solvent shower 60, sucks in and removes dissolved contaminants 7. During vacuuming, suction apparatus 70 may also suck in or remove solvent from inkjet head 410. Suction apparatus 70 may be a small vacuum or other suitable vacuum device, which may also include a directional nozzle to confine the air to a small pathway between nozzle 410 and suction apparatus 70.

Air blower 80, which is apart from suction apparatus 70, blows air toward the lower surface of inkjet head 401 to dry any remaining solvent from inkjet head 401.

Roll brushing apparatus 90 rotates a brush (not shown) on the lower surface of inkjet head 410 to mechanically remove contaminants. The mechanical removal by roll brushing apparatus 90 is useful to remove hardened and solid contaminants. Roll brushing apparatus 90 may be a circular or cylindrical brush rotatable by a motorized or powered hub. The characteristics of the brush, such as the density, type, hardness, and length of the bristles, depends on various factors, such as the hardness and size of the hardened contaminants, the speed of rotation of the brush, and the material of the inkjet head surface.

A cleaning method using the inkjet head cleaning system 10 is described below according to an embodiment of the present invention and shown in FIG. 1.

At <A>, ink in inkjet head 401 is discharged out to remove ink from inside the nozzles of inkjet head 401. The discharge can be with conventional methods, such as simply turning inkjet head 401 so that the nozzles face down and removing any barriers for the ink.

At <B> in one embodiment, inkjet head 401 is placed over solvent shower 60 as close to solvent shower 60 as possible to maximize the amount and force of the solvent spray to inkjet head 401. For example, if solvent shower 60 allows 0.5 mm of minimum distance, the distance is no less than 0.5 mm. The distance can be changed depending on various factors, such as shower pressure and type of shower stream. Shower pressure can be increased for longer distances between inkjet head 401 and solvent shower 60. In one embodiment, shower pressure is no more than 0.2 bar because higher pressures can contaminate neighboring areas of inkjet head 401. As inkjet head 401 is moved over solvent shower 60, solvent shower 60 sprays a solvent toward inkjet head 401 to dissolve contaminants 7 of the surface and especially in and around nozzle 410. In one embodiment, the solvent includes Propyl Glycol Methyl Ether Acetate (PGMEA). The solvent can be various types depending on factors, such as ink composition. In another exemplary embodiment, solvent shower 60 can be a bath type, such that a nozzle of ink jet head 401 can be immersed into solvent in the bath.

At <C>, inkjet head 401 is moved over suction apparatus 70. Inkjet head 401 moves close to suction apparatus 70 to clean inside of the nozzles of inkjet head 401. Suction apparatus 70 sucks and removes the dissolved contaminants 7 through a hole or a plurality of holes. This process may also remove some or all of the solvent. Suction ability depends on various factors, such as the diameter of the holes, the distance from the inkjet head, the speed at which the inkjet head moves, and the size of the nozzles. Smaller diameter of the holes for suction apparatus 70 improves suction ability even though suction pressure is low relatively. In one embodiment, the diameter is no more than 3.0 mm.

At <D>, inkjet head 401 is moved over air blower 80. Air blower 80 blows air or other gas to dry any remaining solvent. In one embodiment, air blower 80 directs air at an angle respect to the lower surface of inkjet head 401. FIG. 1 shows an approximately 45 degree angle, although other angles may also be suitable, as well as being parallel to the nozzle. The angle of air blower 80 need not be fixed, but rather variable with the movement of the inkjet head. Air pressure is controlled so not to contaminate areas other than where the air is blown. Air pressure depends on various factors, such as the diameter of air outlets of air blower 80, the distance to the inkjet head, the speed at which the inkjet head passes, and the size of the nozzles. In one embodiment, air pressure is no more than 0.2 bar, and the diameter of air blower 80 is no more than 3.0 mm.

At <E>, inkjet head 401 is moved over roll brushing apparatus 90, and the lower surface of inkjet head 401 comes into contact with a brush (not shown) of roll brushing apparatus 90. The brush rolls to mechanically remove hardened and/or solid contaminants, which may have resulted from contaminants hardening over time. Use of roll brushing apparatus 90 depends on various factors, such as the amount and size of hardened contaminants on the inkjet head.

Inkjet head 401 can be moved during the cleaning, such as by a conveyor belt, or inkjet head 401 can be stationary, while the other components of the cleaning system are moved, again, such as by a conveyor belt. Further, movement can be continuous or halted as the inkjet head is positioned over specific components.

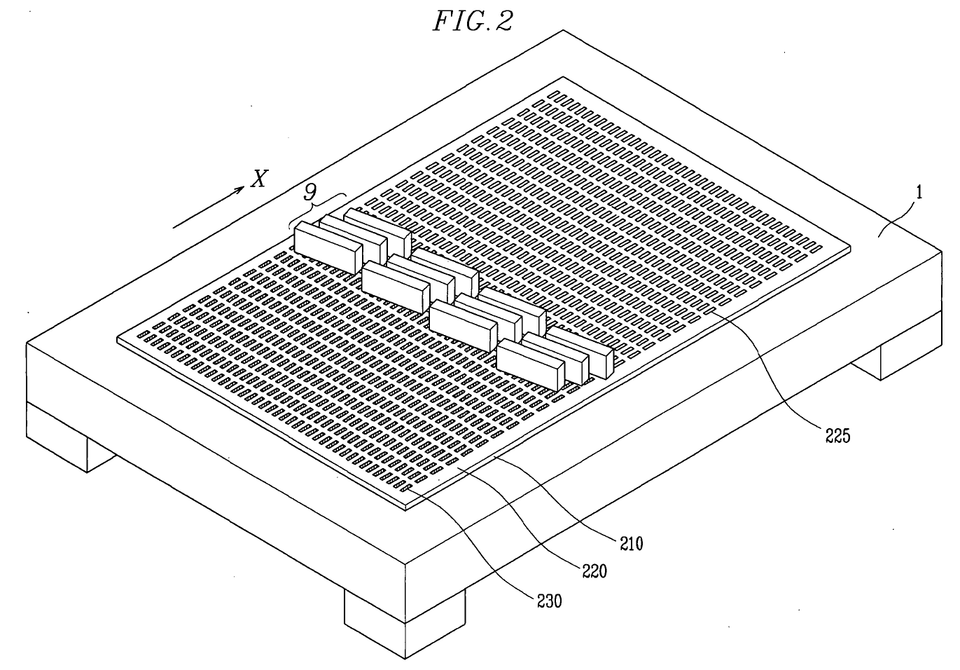

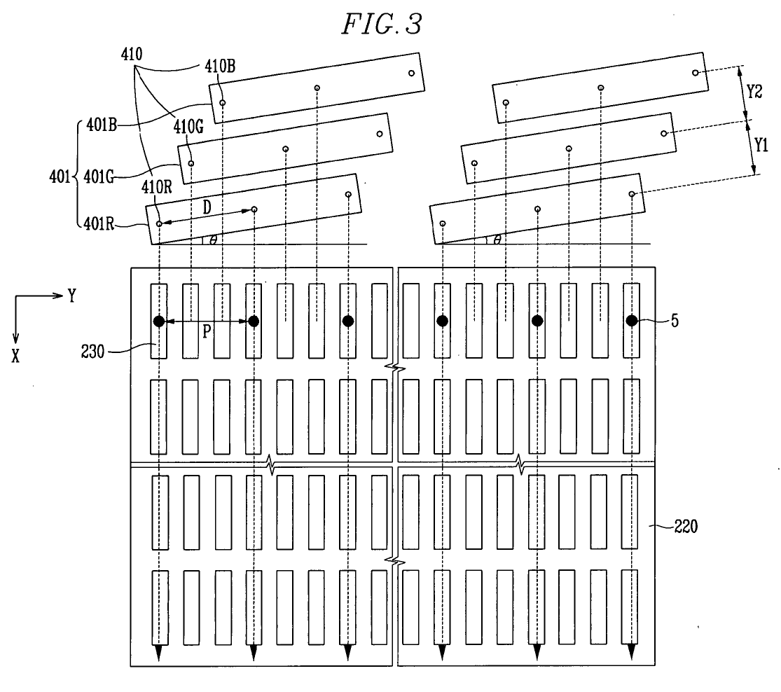

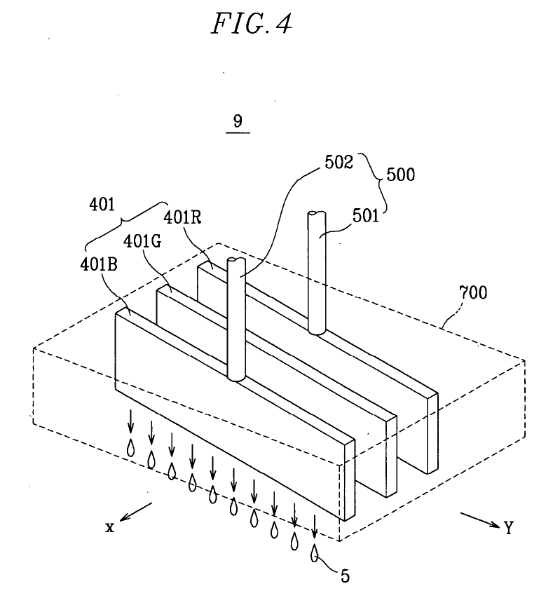

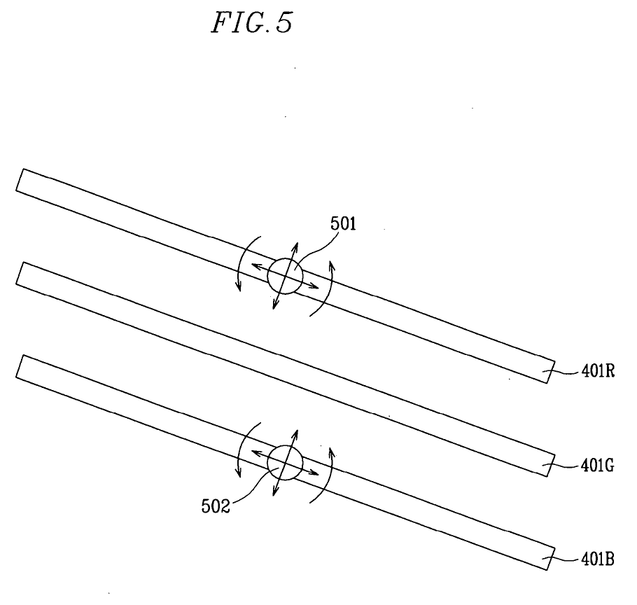

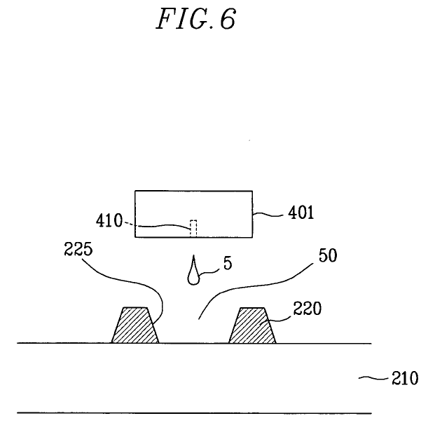

FIG. 2 is a perspective view of an ink jet printing system including inkjet head units 9 disposed over a substrate 210, and FIG. 3 is a plan view illustrating color filters using the inkjet head 401. FIG. 4 is a perspective view of inkjet head unit, and FIG. 5 is a plan view of inkjet head unit. FIG. 6 shows a process to dispense ink on a substrate using inkjet head 401 and form color filters.

Referring to FIGS. 2 to 6, an inkjet printing system includes a stage 1, substrate 210, and a plurality of inkjet head units 9. Each inkjet head unit 9 includes three of inkjet heads 401R, 401G, and 401B as shown in FIG. 3, and alignment axles 500 in the center of inkjet heads 401R and 401B as shown in FIG. 4. Three of inkjet heads 401R, 401G, and 401B can dispense red, green, and blue ink respectively. The lower surface of bar-shaped inkjet heads 401R, 401G, and 401B includes a plurality of nozzles 410R, 410G, and 410B, respectively, as shown in FIG. 3, for dispensing red, green, and blue ink, respectively. Inkjet heads 401 can be shapes other than bar-shaped.

As shown in FIGS. 3 and 4, inkjet heads 401R, 401G, and 401B are spaced apart from each other at an equal distance and inclined at an angle Θ with respect to a Y direction. Because a distance D between nozzles 410 is generally different from a pitch P between color filters 230, inkjet head 410 is rotated to be inclined at an angle Θ with respect to a Y direction so that the distance D corresponds to the pitch P.

As shown in FIGS. 4 and 5, alignment axles 500 include two axles 501 and 502 coupled with inkjet heads 401R and 401B, respectively. Alignment axles 500, which are connected to moving parts (not shown), move the corresponding inkjet heads in the X direction, Y direction, and rotationally (FIG. 5). A gap Y1 between nozzles 401G and 401R can coincide with a gap Y2 between nozzles 401G and 401B by moving alignment axes 501 and 502 accordingly. This enables ink to be dispensed at an equal vertical distance in a column of color filters 230.

Referring to FIGS. 2, 3, and 6, a method of forming color filters is described. Inkjet head unit 9 is disposed over substrate 210 on stage 1 of the inkjet printing system. Nozzles 410 are moved using alignment axles 500, as discussed above, so that nozzles 410 are properly aligned in the Y direction with respect to openings or apertures 225 and light blocking members 220. Inkjet head unit 9 moves in an X direction and dispenses ink 5 toward the substrate so that nozzle 401 places ink on the aperture 225 between light blocking members 220. Ink 5 in apertures 225 is dried to form a color filter 230.

Because inkjet heads 401R, 401G, and 401B of inkjet head unit 9 of FIG. 4 dispense red, green, and blue ink, respectively, red, green and blue color filters can be formed at the same time by scanning inkjet head unit 9 over the substrate 210. If desired, color filters of the same color can be formed separately, such as by only dispensing ink or moving inkjet heads of a single color.

As shown in FIG. 2, a plurality of inkjet head units 9 are installed in inkjet printing system and can move simultaneously to form concurrently all color filters 230 in a Y direction. In another example, one inkjet head unit 9 scans in the X direction to form color filters in the X direction corresponding to nozzles 401 of the inkjet head and inkjet head unit 9 moves in a Y direction to form all color filters in the Y direction. This operation is repeated to complete all of color filters 230.

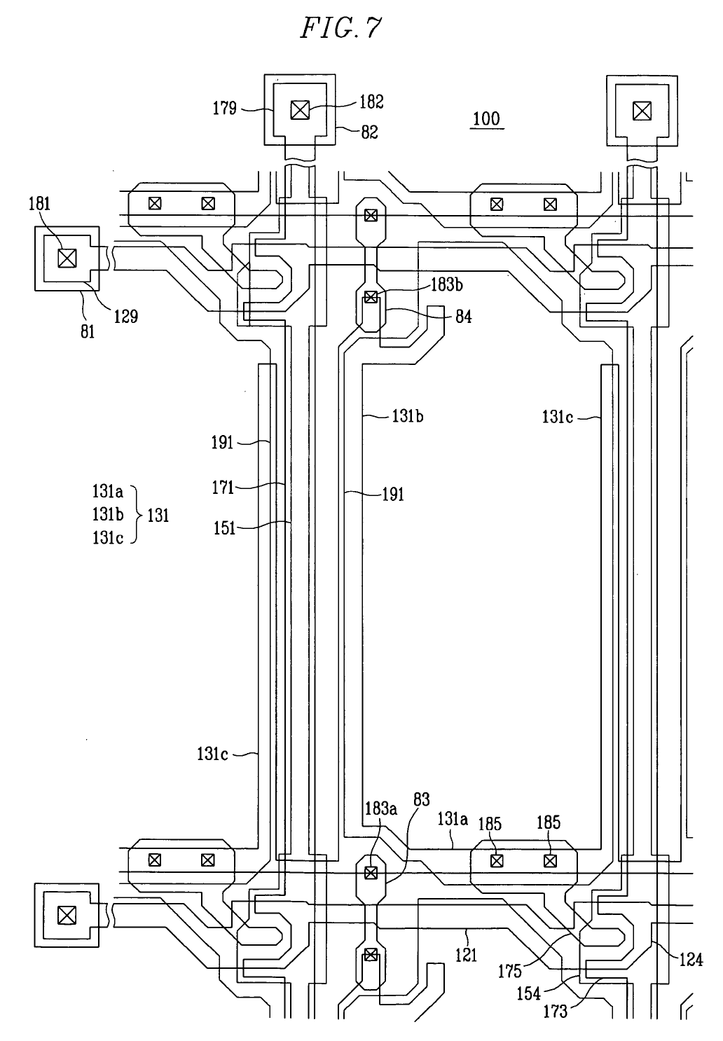

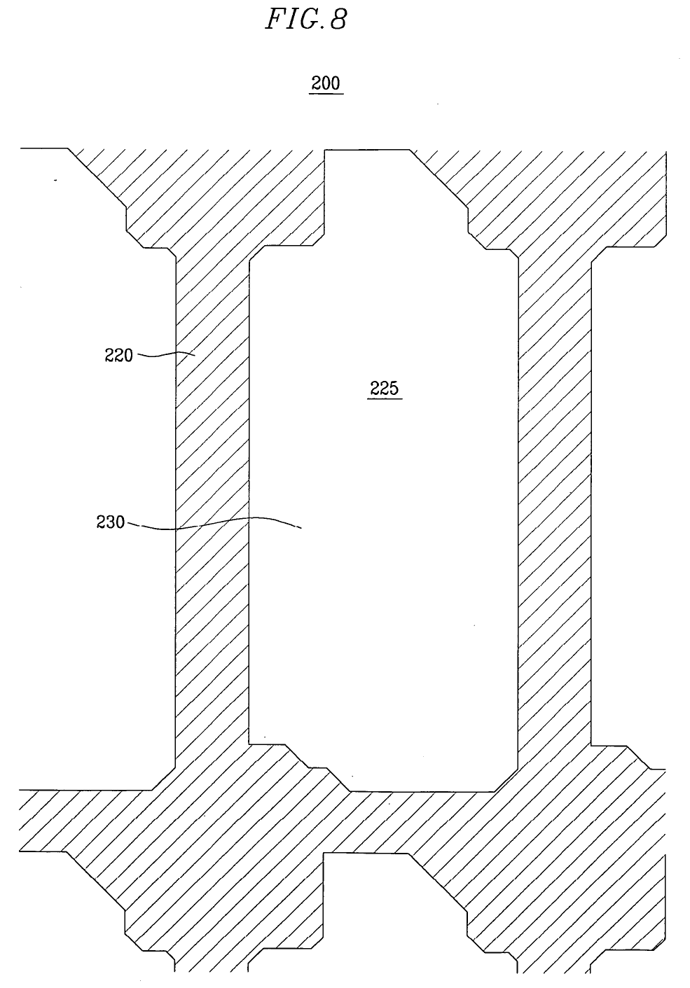

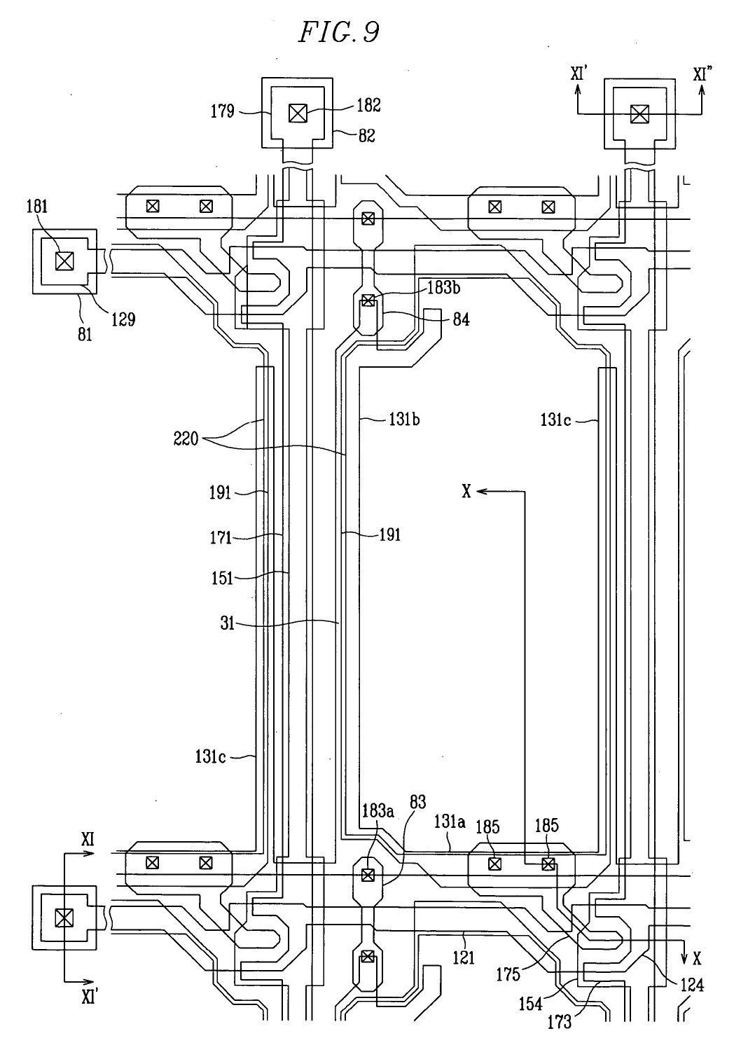

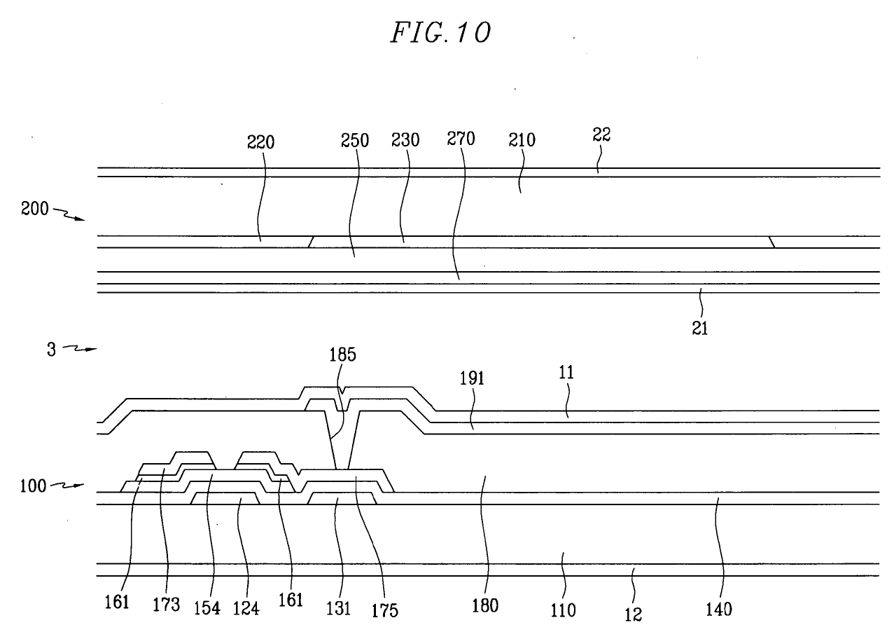

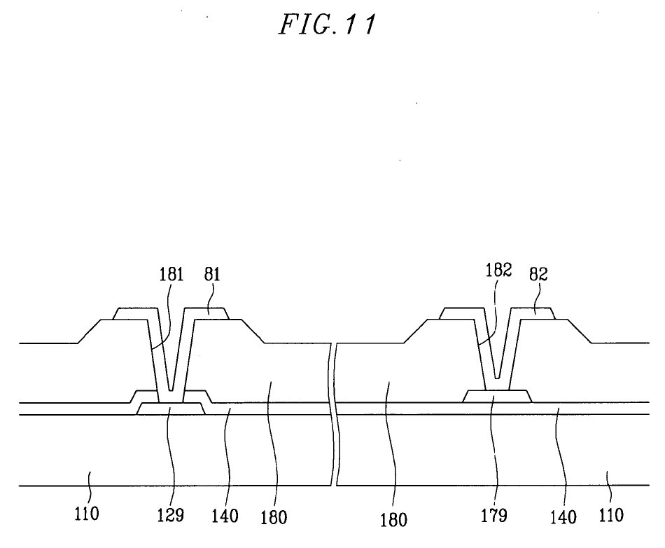

Referring to FIGS. 7 to 11, a liquid crystal display having color filters formed by using an inkjet printing system is described. FIG. 7 is a plan view of a thin film transistor array panel for a liquid crystal display, and FIG. 8 is a plan view of color filters for a liquid crystal display. FIG. 9 is a plan view of a liquid crystal display formed by assembling the thin film transistor array panel of FIG. 7 and the color filter array panel of FIG. 8. FIG. 10 is a cross sectional view taken along the line X-X′ of FIG. 9, and FIG. 11 is a cross sectional view taken along the lines XI-XI′ and XI′-XI″ of FIG. 9.

Referring to FIGS. 7 to 11, a liquid crystal display includes a thin film transistor array panel 100 having pixel electrodes 191, a color filter array panel 200, and a liquid crystal layer 3 disposed between thin film transistor array panel 100 and color filter array panel 200 (FIG. 10). The pixel electrode 191 provided with a data voltage and color filter array panel 200 having a common electrode 270 provided with a common voltage generate an electric field in liquid crystal layer 3 to orient liquid crystal molecules. An amount of light passing through liquid crystal layer 3 depends on the orientation of the liquid crystal molecules.

Thin film transistor array panel 100 includes a plurality of gate lines 121, a plurality of storage electrode lines 131, a plurality of data lines 171 including data electrodes 175, and a plurality of pixel electrodes 191.

Gate lines 121 and storage electrode lines 131 are formed on an insulating substrate 110 such as a transparent glass or a plastic.

Gate lines 121 carry a gate signal and extend in a horizontal direction. Each gate line 121 includes a plurality of gate electrodes 124 expanded upward and downward from gate line 121, and an end portion 129 having a larger width than gate line 121 for connecting a different layer or an external driving circuit (not shown). A gate driving circuit generating a gate signal can be mounted on a flexible printed circuit film (not shown) connected to or integrated on the substrate 110. Where the gate driving circuit is integrated on the substrate 110, gate line 121 can extend to connect to the gate driving circuit.

Storage electrode lines 131 include main storage electrode lines 131a extending in parallel with gate line 121 and pairs of first storage electrodes 131b and second storage electrodes 131c extending from each main storage electrode line 131a. Each first storage electrode 131b and second storage electrode 131c have a connection portion to main storage electrode line 131a and an opposite portion which is divided into a straight portion and a bent portion. Each main storage electrode line 131a, first storage electrode 131b, and second storage electrode 131c overlaps partially with each pixel electrode 191 to form a storage capacitor. However, storage electrode lines 131 may have different shapes and arrangements.

Pixel electrode 191 and the common electrode (not shown) form a liquid crystal capacitor with a liquid crystal dielectric for storing electrical charges. The storage capacitor is formed in parallel to the liquid crystal capacitor to enhance the capability of storing electrical charges.

Gate lines 121 and storage electrode lines 131 can be formed of a metal such as Al, Ag, Cu, Cr, Ti, Ta, Mo, or alloys thereof. Gate lines 121 and storage electrode lines 131 may have a multi-layered structure including a lower and an upper conductive film. The lower film can be a low resistivity metal, such as Al, Ag, Cu, and alloys thereof, for reducing signal delay or voltage drop in the gate lines 121 and the storage electrode lines 131. On the other hand, the upper film can be a material such as Mo, Cr, Ta, Ti and alloys thereof, which have good contact characteristics with other materials such as indium tin oxide (ITO) and indium zinc oxide (IZO). Exemplary combinations of the lower film material and the upper film material are Al or Al alloy with Mo or Mo alloy, respectively, and Cr with Al or Al alloy, respectively. Other materials for the upper and lower film material may also be suitable.

Gate lines 121 and storage lines 131 may have tapered lateral sides having an inclination angle in the range of about 30 to 80 degrees, relative to the surface of the substrate 110.

A gate insulating layer 140 formed of silicon nitride (SiNx) or silicon oxide (SiOx), as shown in FIGS. 10 and 11, is formed on gate lines 121 and storage lines 131. These tapered lateral sides ensure that subsequent layers to be deposited will conform, without a break, to the underlying structure.

A plurality of semiconductor strips 151 formed of hydrogenated amorphous silicon (a-Si) or polysilicon are formed on the gate insulating layer 140. Semiconductor strips 151 extend in a vertical direction and include projections 154 protruded toward gate electrodes 124. The width of semiconductor strips 151 increases at a portion corresponding to gate lines 121 and storage lines 131 to prevent shorting of gate line 121 and storage electrode line 131 with data line 171.

Data lines 171 including source electrodes 173 and a plurality of drain electrodes 175 are formed over semiconductor strips 151 and projections 154. Data lines 171 carry data signals and extend in a vertical direction. Each data line 171 crosses over gate lines 121 and storage electrode lines 131 and is disposed between first storage electrode 131a and second storage electrode 131b. Each data line 171 has an end portion 179 with larger width, which is connected to a different layer or an external driving circuit (not shown). A data driving circuit generating a data signal can be mounted on a flexible printed circuit film (not shown) connected to or integrated on the substrate 110. Where the data driving circuit is integrated on the substrate 110, the end portion 179 of data line 171 can extend to connect to gate driving circuit.

Drain electrodes 175 are apart from data line 171 and face source electrodes 173 with respect to gate electrodes 124. Each drain electrode 175 has expanded portions partially overlapping main storage electrode line 131a and narrow portions encompassed by “U” shape source electrodes 173.

Agate electrode 124, a source electrode 173, and a drain electrode 175 form a thin film transistor as shown in FIG. 10. A channel (not shown) of the thin film transistor is formed on the semiconductor projection 154 between source electrode 173 and drain electrode 175.

Data line 171 and drain electrode 175 may be formed of a refractory metal, such as Mo, Cr, Ta, Ti, or alloys thereof or a multi-layer structure having a refractory metal and a low resistivity metal, such as Al and Cu. One example is a lower Cr, Mo, or alloys thereof with an upper Al or Al alloy. Another example is a triple layer structure having a lower Mo or Mo alloy, an intermediate Al or Al alloy, and an upper Mo or Mo alloy.

Data line 171 and drain electrode 175 may have tapered lateral sides having an inclination angle in the range of about 30 to 80 degrees, relative to the surface of the substrate 110.

A plurality of ohmic contact layers 161 are formed between semiconductor strips 151 and data lines 171 to decrease resistances between them. In one embodiment, ohmic contact layers 161 are formed of silicide or n+hydrogenated amorphous silicon highly doped with n type impurity such as phosphorus (P).

A passivation layer 180 of FIGS. 10 and 11 is formed on data lines 171, drain electrodes 175, semiconductor projections 154 and gate insulating layer 140. In one embodiment, passivation layer 180 is formed of inorganic insulating material such as silicon nitride and silicon oxide or organic insulating material. The organic insulating material can be photo sensitive and/or have a dielectric constant less than 4.0. Also, passivation layer 180 can be double layered structure having a lower layer of inorganic insulating material and an upper layer of organic insulating material.

Referring to FIGS. 7 and 11, passivation layer 180 has a plurality of contact holes 182 and 185, which expose end portions 179 of data lines 171 and drain electrodes 175, respectively. A plurality of contact holes 181, 183a, and 183b are formed through passivation layer 180 and gate insulating layer 140 to expose end portions 129 of gate lines 121, portions of storage electrode lines 131a, and portions of storage electrode 131b, respectively.

A plurality of pixel electrodes 191, a plurality of overpasses 83, and a plurality of contact assistants 81 and 82 are formed on passivation layer 180 and formed of a transparent conductive material such indium tin oxide or indium zinc oxide or a reflective conductive material such as Al, Ag, Cr or alloys thereof.

Each pixel electrode 191 is connected physically and electrically to drain electrode 175 through contact holes 185, and a data voltage is applied to each pixel electrode 191 from drain electrode 175.

Contact assistants 81 and 82 are connected to end portions 129 of gate lines 121 and end portions 179 of data lines 171 through contact holes 181 and 182, respectively. Contact assistants 81 and 82 enhance the adherence of end portions 129 and 179 with an external circuit and protect the end portions 129 and 179.

Overpasses 83 cross over gate lines 121 and connect main storage electrode lines 131a to first storage electrodes 131b through contact holes 183a and 183b. Storage electrode line s131 and overpasses 83 can be used for repairing defects in gate lines 121, data lines 171, or the TFTs.

Referring to FIGS. 8 to 11, a color filter array panel 200 is disposed over thin film transistor panel 100. Color filter array panel 200 includes a light blocking member 220, color filters 230, an overcoat 250, and a common electrode 270.

Light blocking member 220 (e.g., a black matrix) is formed on a insulating substrate 210 such as a transparent glass or plastic to prevent light from leaking between pixel electrodes 191. Light blocking member 220 has a plurality of apertures 225, which are located on the area corresponding to pixel electrodes 191 and may have substantially the same planar shape as pixel electrodes 191. In another example, light blocking member 220 can be formed only in the area corresponding to data lines 171, gate lines 121, and the thin film transistors. Light blocking member 220 holds ink 5 when inkjet head 401 dispenses ink 5 into the aperture as shown in FIG. 6.

Ink forms color filters 230, which are encompassed by light blocking member 220 and correspond to pixel electrodes 191. The color filters may extend substantially in the longitudinal direction along pixel electrodes 191, with each color filter 230 representing red, green, or blue.

Overcoat 250 is formed on color filters 230 and light blocking member 220. Overcoat 250 is formed from an organic insulating material, provides a flat surface, and prevents color filters 230 from being exposed. In some embodiments, overcoat 250 is omitted.

Common electrode 270 is formed on overcoat 250 and formed of transparent conductive material such as indium tin oxide and indium zinc oxide in one embodiment.

The inner surfaces on panels 100 and 200 are coated with alignment films 11 and 21, respectively, which keep the liquid crystal molecules aligned in the initial vertical orientation. In another embodiment, the alignment films 11 and 21 may orient liquid crystal molecules in a horizontal direction.

A pair of polarizer 12 and 22 is provided on the outer surfaces of the panels 100 and 200 such that their transmission axes are crossed, and one of the transmission axes is parallel to the gate lines 121.

The liquid crystal display may further include at least one retardation film (not shown) which compensates for the retardation of light passing through liquid crystal 3 disposed between the panels 100 and 200, and polarizers 12 and 22, respectively.

The liquid crystal display may further include a backlight unit (not shown) to provide light to the polarizers 12 and 22, the retardation film, the panels 100 and 200, and the liquid crystal layer 3.

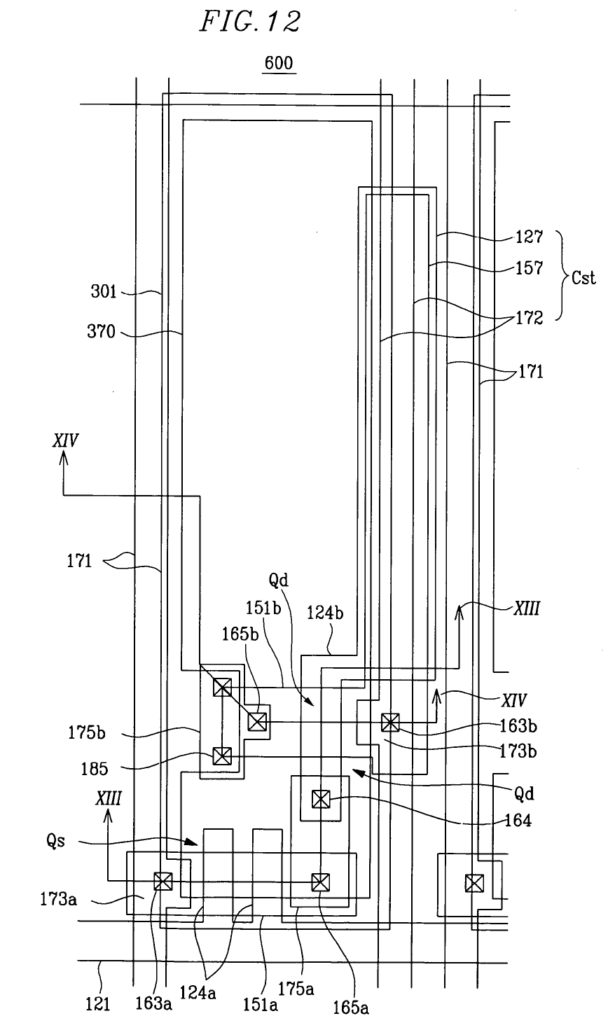

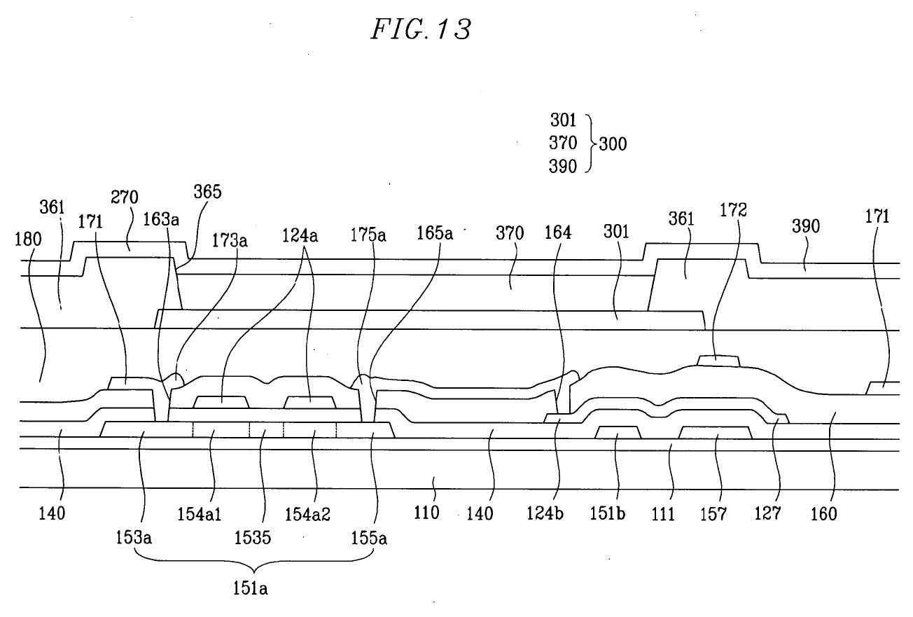

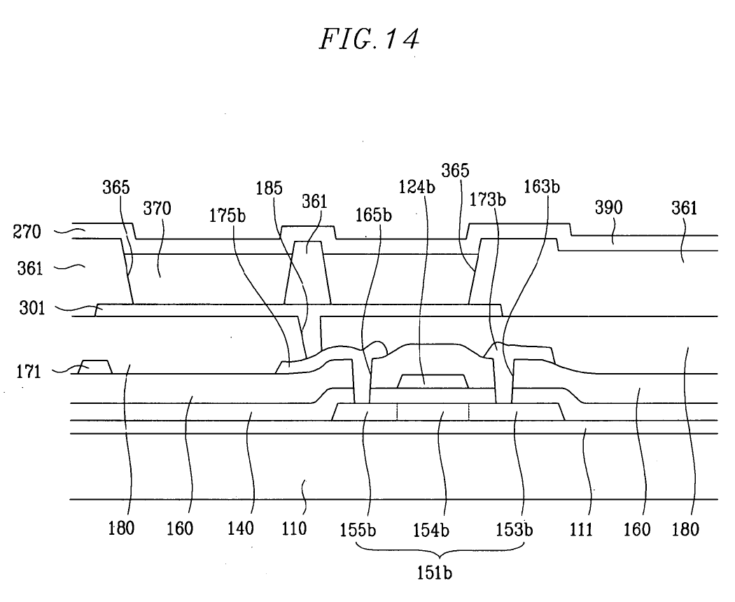

Referring to FIGS. 12 and 14, an organic light emitting display, which has an organic light emitting layer 370 and formed with an inkjet printing system cleaned by an inkjet head cleaning system according to an embodiment of the present invention, is described. FIG. 12 is a plan view of a pixel 600 of organic light emitting display, and FIGS. 13 and 14 are cross sectional views taken along the line XIII-XIII′ and XIV-XIV′ of FIG. 12, respectively.

Referring to FIG. 12, organic light emitting display includes a plurality of pixels 600 having a data line 171 extending in a vertical direction, a gate line 121 extending in a horizontal, and a driving voltage line 172 in parallel with data line 171. Pixels 600 are arranged in a matrix type. Each pixel 600 includes a switching transistor Qs, a driving transistor Qd, a storage capacitor Cst connected to driving transistor Qd and driving voltage line 172, and a light emitting element 300 having an organic light emitting member 370 of FIG. 13.

Switching transistor Qs is connected to data line 171 and gate line 121 to carry a data signal to a control electrode 124b of driving transistor Qd. Driving transistor Qd turns on by a data signal, and then driving voltage line 172 provides a driving current to organic light emitting element 300 through driving transistor Qd. Organic light emitting element 300 is provided with the driving current emits light from organic light emitting layer 370. Brightness of light emitted from organic light emitting layer 3 depends on an amount of the driving current.

Referring to FIGS. 12 to 14, a blocking film 111 made of silicon nitride or silicon oxide is formed on an insulating substrate 110 such as a transparent glass or plastic. The blocking film may be a dual-layered structure.

First and second semiconductors 151a and 151b made of polysilicon is formed on blocking film 111. Each of semiconductors 151a and 151b includes extrinsic regions doped with n type or p type conductive impurities and intrinsic regions. Extrinsic regions form a first source region 153a and a first drain region 155a of switching transistor Qs, and a second source region 153b and a second drain region 155b of driving transistor Qd. First source region 153a, first drain region 155a, and an intermediate region 1535 disposed between them are doped with n type impurities.

Intrinsic regions between first source region 153a, first drain region 155a, and intermediate region 1535 form first channel regions 154a1 and 154a2 of switching transistor Qs. Second source region 153a and second drain region 155b are doped with p type impurities. Second source region 153a extends upward to form a first electrode 157 of storage capacitor Cst. Intrinsic region between second source region 153a and second drain region 155b forms a second channel region 154b of driving transistor Qd.

On the other hand, extrinsic regions 153a and 155a of first semiconductor 151a can be doped with p type impurities, or extrinsic regions 153b and 155b of second semiconductor 151b can be doped with n type impurities. For example, p type impurities can be boron (B) and gallium (Ga), and n type impurities can be phosphorous (P) and arsenic (As).

In another example, semiconductors 151a and 151b can be formed of amorphous silicon, and an ohmic contact layer can be formed on the amorphous silicon to decrease contact resistances with other conductive layers.

A gate insulating layer 140 is formed on semiconductors 151a and 151b, and blocking film 111. Gate insulating layer 140 can be formed of silicon nitride or silicon oxide, for example.

Gate line 121 having a first control electrode 124a and a second control electrode 124b are formed on gate insulating layer 140. First control electrode 124a protrudes upward from gate line 121 to cross over first semiconductor 151a and overlap first channel regions 154a1 and 154a2. First control electrode 124a, first source region 153a, first drain region 155a, and first channel regions 154a1 and 154a2 form switching transistor Qs. Gate line 121 carries a gate signal toward first control electrode 124a to turn on switching transistor Qs.

Second control electrode 124b is apart from gate line 121 and crosses over second semiconductor 151b to overlap second channel region 155b. Second control electrode extends upward to form a second electrode 127 of storage capacitor Cst. First electrode 157 and second electrode 127 form storage capacitor Cst to store and maintain a voltage difference between second control electrode 124b of driving transistor Qd and driving voltage line 172.

Interlayer insulating film 160 is formed on gate line 121, second control electrode 124b, and gate insulating layer 140. Interlayer insulating film 160 is formed of inorganic material such as silicon nitride and silicon oxide, organic material, or insulating material having low dielectric constant, such as less than 4.0. For example, a suitable low dielectric material is a-Si:C:O and a-Si:O:F. The organic material may also be photo-sensitive.

Interlayer insulating film 160 has contact holes 164 to expose second control electrodes 124b. Interlayer insulating film 160 and gate insulating layer 140 have contact holes 163a, 163b, 165a, and 165b. First source region 153a and first drain region 155a are exposed through contact holes 163a and 165a, respectively. Second source region 153b and second drain region 155b are exposed through contact holes 163b and 165b, respectively.

Data lines 171, driving voltage lines 172, and first and second output electrodes 175a and 175b are formed on interlayer insulating film 160.

Data lines 171 carry data signals and cross over gate lines 121. Each data line 171 includes first input electrodes 173a connected to first source regions 153a through contact holes 163a.

Driving voltage lines 172 carry voltages and cross over gate lines 121. Each driving voltage line 172 includes second input electrodes 173b connected to second source regions 153b and second electrodes 157 of storage capacitor Cst through contact holes 163b. Driving voltage line 172 can be connected to other driving voltage lines (not shown).

First output electrode 175a is apart from data line 171 and driving voltage line 172. First output electrode 175 connects to first drain region 155a and to second control electrode 124b through contact holes 165a and 164, respectively.

Second output electrode 175b is apart from driving voltage line 172, data line 171, and first output electrode 175a, and is connected to second drain region 155b through contact hole 165b.

Gate line 121 and data line 171 can be formed of at least one of the same conductive material as gate line 121 and data line 171 of a thin film transistor array panel for liquid crystal display of FIG. 7.

A passivation layer 180 is formed on data line 171, driving voltage line 172, first and second output electrodes 175a and 175b, and interlayer insulating film 160. Passivation layer has a contact hole 185 to expose second output electrode 175b.

A pixel electrode 301 is formed on passivation layer 180. Pixel electrode 301 is connected to second output electrode 175b through contact hole 185. Pixel electrode 301 is formed of a transparent electrode such as indium tin oxide and indium zinc oxide.

A partition 361 is formed on passivation layer 180 and a portion of pixel electrode 301. Partition 361 has an opening 365 and is formed of inorganic material or organic insulating material. The partition may be made of a photosensitive material containing a black pigment such that the partition acts as a light blocking member.

Organic light emitting member 370 is formed in the opening 365 encompassed by partition 361. Organic light emitting member 370 includes a emitting layer (not shown) and an auxiliary layer (not shown) to improve emitting efficiency. For example, the auxiliary layer includes an electron transport layer, a hole transport layer, an electron injecting layer, and a hole injecting layer.

Organic light emitting member 370 is formed of organic material, which emits light of at least one color of red, green, and blue. Organic light emitting member 370 can be formed by using an inkjet printing system cleaned by an inkjet head cleaning system 10 according to an embodiment of the present invention.

Partition 361 holds ink of organic material forming organic light emitting member 370 as like blocking member 225 of FIG. 6.

A common electrode 390 is formed on organic light emitting member 370 and partition 361. A common voltage (Vcom) is applied to common electrode 390 and is formed of calcium, barium, magnesium, aluminum, or combinations thereof.

Pixel electrode 301, light emitting member 370, and common electrode 390 form organic light emitting element 300. Pixel electrode 301 forms an anode, and common electrode 390 forms a cathode. On the other hand, pixel electrode 301 and common electrode 390 can form a cathode and an anode, respectively.

The organic light emitting display can be categorized as a top emission type or a bottom emission type. A top emission type includes a transparent pixel electrode and an opaque common electrode to display images through substrate 110. On the other hand, a bottom emission type includes an opaque pixel electrode and a transparent common electrode to display images through a common electrode.

In another exemplary embodiment, an organic light emitting display can include semiconductors 151a and 151b made of amorphous silicon. An ohmic contact layer (not shown) can be disposed between data line 171 and semiconductors 151a and 151b. Gate line 121 and second control electrode 124b can be formed under semiconductors 151a and 151b to form transistor similar in structure as the one shown in FIG. 10.

According to an embodiment of the present invention, an inkjet head cleaning system and a method using thereof removes contaminants without damage of the under surface of the inkjet head by using solvent. Also, a roll brushing apparatus can be used to mechanically remove hard and solid contaminants, which may remain even after application of the solvent.

Although the invention has been described with reference to particular embodiments, the description is an example of the invention's application and should not be taken as a limitation. Various adaptations and combinations of the features of the embodiments disclosed are within the scope of the invention as defined by the following claims.

What is claimed is:

1. An inkjet head cleaning system comprising:
a shower adapted to spray a solvent onto a lower surface of an inkjet head for dissolving contaminants on the inkjet head;
a vacuum spaced apart from the shower adapted to suck the dissolved contaminants from the inkjet head; and,
a blower spaced apart from the vacuum adapted to blow air toward the lower surface of the inkjet head.

2. The inkjet head cleaning system of claim 1, further comprising a brush adapted to roll in contact with the lower surface of the inkjet head and remove remaining contaminants from the lower surface of the inkjet head.

3. The inkjet head cleaning system of claim 2, wherein the remaining contaminants are solid contaminants.

4. The inkjet head cleaning system of claim 1, wherein the shower, the vacuum, and the blower are formed on a substrate.

5. The inkjet head cleaning system of claim 1, wherein the solvent is sprayed into and around nozzles of the inkjet head.

6. A method of cleaning an inkjet head comprising;
discharging ink from the inkjet head;
spraying a solvent toward a lower surface of the inkjet head to dissolve contaminantd on the inkjet head;
sucking the dissolved contaminants from the inkjet head; and
blowing air toward to the lower surface of the inkjet head.

7. The method of claim 6, further comprising contacting the lower surface of the inkjet head with a brushing apparatus and rolling the brushing apparatus to remove remaining contaminants.

8. The method of claim 7, wherein the remaining contaminants are solid.

9. The method of claim 6, further comprising brushing the lower surface of the inkjet head to remove remaining contaminants.

10. The method of claim 6, further comprising moving the inkjet head for the spraying, sucking, and blowing.
